(19) United States
(12) Patent Application Publication
(10) Pub. No.: US 2004/0166311 A1
(43) Pub. Date: Aug. 26, 2004

(54) Electrostatic spinning of aromatic polyamic acid

(75) Inventors: Kap Seung Yang, Buk-Ku (KR); Yeong Og Choi, Hwasun-Gun (KR)

Correspondence Address: DORITY & MANNING, P.A., POST OFFICE BOX 1449, GREENVILLE, SC, 29602-1449, US

(73) Assignee: Clemson University

(21) Appl. No.: 10/374,735

(22) Filed: Feb. 25, 2003

(51) Int. Cl. D04H 3/00; C08G 69/28; C08G 69/26; D02G 3/00; C08G 79/02; B32B 9/00; C08G 75/00; C08G 69/42; D04H 13/00; D04H 5/00; D04H 1/00; D02J 1/22; D01D 5/12; D01F 6/00; C08G 63/00

(52) U.S. Cl. 428/365; 442/327; 428/367; 528/350; 528/351; 528/352; 528/353; 528/188; 264/205; 264/210.5; 264/210.8; 264/290.5

(57) ABSTRACT

The present invention is directed to a process for electrostatically spinning fibers of polyamic acid and the fibers thus produced as well as the nonwoven webs that may be formed from the fibers. According to the processes of the present invention, polyamic acid solutions may be electrostatically spun to form fibers of very small diameter, such as, for instance, less than about 5 μm in average diameter. The fibers may be formed into a nonwoven web having very high specific surface area and large porosity. The polyamic acid may be converted to polyimide to form a polyimide nonwoven web. The polyimide nonwoven web may then be activated through a carbonization process to enhance the electrochemical properties of the web. The nonwoven webs of the invention may be utilized in a variety of electrochemical applications including, for example, electrical double layer capacitors.

### BACKGROUND OF THE INVENTION

Aromatic polyimides have been investigated extensively for use in applications ranging from microelectronics to high-temperature insulators due to their excellent thermal and chemical stability. These materials also display good electrical and mechanical properties. However, the very characteristics which make these materials attractive also cause the materials to be very difficult to work with. For instance, their excellent chemical stability makes them difficult to dissolve, making them difficult to process from solution. Also, aromatic polyimides have a very high glass transition temperature and decompose prior to melting, making thermal processing impractical. As such, aromatic polyimides are generally prepared from polyamic acid precursors.

Polyamic acid materials have been found to be easier to process than aromatic polyimides due to their good solubility in aprotic solvents such as N,N-dimethylacetamide, N-methyl-2-pyrrolidone, N,N-dimethylformamide, and mixtures of tetrahydrofuran and methanol. Generally, polyimide materials have been prepared by forming a polyamic acid precursor, forming the polyamic acid precursor into the desired product form, and converting the polyamic acid to polyimide through dehydration and cyclization reactions either chemically, i.e., with mixtures of aliphatic carboxylic acid anyhydrides and tertiary amines, or thermally.

Product forms for the polyamic acid precursors have included films, coatings, laminates, and fibers which may be further processed to form textile materials. Polyamic acids have been spun to form fibers with both wet and dry spinning methods (see, for example, U.S. Pat. No. 3,179,614 to Edwards, et al. and U.S. Pat. No. 3,415,782 to Irwin, et al.). Fibers produces by these methods have tended to display poor mechanical properties, however, due to low drawing of the fiber during spinning. More recently, dry-jet wet spinning of aromatic polyamic acid-imide copolymer fibers has been reported (‘Dry-jet wet spinning of aromatic poyamic acid fiber using Chemical Imidization,’ Seung Koo Park, Richard J. Farris, Polymer 42(2001)10087-10093) resulting in fibers having smaller diameters, such as about 19 μm, and somewhat improved mechanical properties.

A need currently exists in the art for a process of forming polyamic acid precursor materials into extremely small diameter fibers which may subsequently be formed into aromatic polyimide nonwoven webs.

### SUMMARY OF THE INVENTION

In one embodiment, the present invention is directed to a process for electrostatically spinning a nonwoven web from a solution comprising between about 10 wt % and about 15 wt % polyamic acid. Optionally, a polyamic acid solution can first be formed such as by reaction of equimolar amounts of a dianhydride and an organic diamine in a solvent. For instance, a pryomellitic dianhydride or a biphenyltetracarboxylic dianhydride may be used. In one embodiment, the polyamic acid can have the following structure:

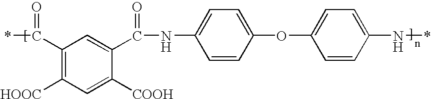

The polyamic acid solution can be electrostatically spun in an electrical field to form fibers. The fibers can then be collected on a collecting device where they can self-adhere to form a nonwoven web.

In one embodiment, the potential difference of the electric field induced in the spinning process can be less than about 30 KV. For example, the potential difference can be between about 12 KV and about 15 KV. Additionally, the process can be carried out at ambient temperatures.

In one embodiment, the solvent can have a boiling point of less than about 100° C. For example, the solvent can be a tetrahydrofuran/methanol mixture.

The process can also include conversion of the aromatic polyamic acid to polyimide following electrostatic spinning of the polyamic acid. In this embodiment, the web can include electrostatically spun polyimide fibers. If desired, the polyimide-containing web may then be carbonized to enhance the electrochemical properties of the web. That is, at least a portion of the unsaturated bonds can be saturated with carbon. If desired, the carbonized web can be additionally graphitized.

The fibers formed according to the processes of the present invention can be extremely small diameter fibers. For example, the fibers can have an average diameter of less than about 5 μm. In one embodiment, the fibers can have an average diameter of less than about 3 μm. For instance, the fibers can have an average diameter of between about 200 nm and about 3 μm.

The nonwoven webs of the present invention can display high electrical conductivities even when the webs are not compressed. For example, in various embodiments, the electrical conductivities of the noncompressed nonwoven webs of the present invention can be greater than 0.0144 S/cm, greater than 1.0 S/cm, greater than 1.73 S/cm, or greater than 2.50 S/cm. For instance in one embodiment, the nonwoven web can have an electrical conductivity of at least about 5.26 S/cm when the web is not compressed.

In one embodiment, the present invention is directed to an electrical double layer capacitor (EDLC) in which a web formed according to the processes of the present invention may be one or optionally both electrodes of the EDLC. An EDLC of the present invention will also include an electrolyte which can, in various embodiments, be an organic electrolyte solution or an aqueous electrolyte solution.

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying figures, in which:

FIG. 1 is a schematic diagram of an electrostatic spinning process such as may be used in the present invention;

FIG. 2 is a scanning electron microscope view of beads formed from an attempted electrostatic spinning of polyamic acid solution in N-methyl-2-pyrrolidone;

FIG. 3a includes two scanning electron microscope views of a nonwoven web formed of aromatic polyamic acid;

FIG. 3b includes two scanning electron microscope views of the web shown in FIG. 3a following thermal conversion of the aromatic polyamic acid to polyimide;

FIGS. 4a-4d are scanning electron microscope views which illustrate diameter changes of fibers throughout the process of the present invention;

FIG. 5 is a flow diagram of embodiments of the process of the present invention;

FIG. 6 shows the viscosity of a polyamic acid polymer solution as a function of shear rate;

FIG. 7 is a differential scanning calorimeter thermogram of an electrostatically spun polyamic acid nonwoven web;

FIG. 8 compares the IR spectrum of an electrostatically spun aromatic polyamic acid nonwoven web and the same web following conversion to polyimide; and

FIG. 9 graphically illustrates the electrical conductivities of carbonized and graphitized polyimide webs as a function of heat treatment temperature.

Repeat use of reference characters in the present specification and drawings is intended to represent the same or analogous features or elements of the present invention.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used in another embodiment to yield a still further embodiment. Thus, it is intended that the present invention cover such modifications and variations as come within the scope of the appended claims and their equivalents.

In general, the present invention is directed to a process for forming fibers from a solution of aromatic polyamic acid and the fibers and nonwoven webs that may be formed according to the disclosed processes. For example, according to the processes of the present invention, polyamic acid solutions may be electrostatically spun to form fibers of very small diameter, such as, for instance less than about 5 μm in diameter. In conjunction with the electrostatic spinning process, the fibers may be collected so as to form a nonwoven web having a very large specific surface area and porosity. These characteristics make non-woven fabrics produced by electrostatic spinning processes attractive for many applications, such as filters, membranes, wound dressings, vascular grafts, composite reinforcements, and a variety of uses in nanoelectronics.

In one embodiment, the polyamic acid web may be further processed to convert the aromatic polyamic acid to the corresponding polyimide to form a polyimide nonwoven web. Polyimides in general have found wide use in a variety of products. For example, polyimide materials have been used in the past as adhesives, coatings, composite matrices, fibers, films, foams, membranes, etc. Recently, a variety of space applications have been considered for polyimide materials including, for example, membranes on antennas, solar sails, sunshades, thermal/optical coatings, and multi-layer thermal insulation blanket materials. The electrostatically spun polyimide nonwoven webs of the present invention show great promise in these as well as many other applications due to their high porosity, large specific surface area, and excellent electrical and mechanical properties.

In certain embodiments of the present invention, the polyimide webs may be further processed, such as by carbonization or graphitization processes. Carbonized materials have become very attractive for electrochemical applications due in part to their accessibility, easy processability, relatively low cost, and environmental friendliness. Carbon materials are also attractive due to their electricochemical characteristics. For instance, carbon-based electrodes are well polarizable. Additionally, the amphoteric character of carbon allows use of the material in either donor or acceptor state. As such, carbonized webs of extremely small diameter fibers, such as may be formed according to the processes of the present invention, may find application in a number of electrochemical materials, such as, for instance, electrochemical capacitors.

In one embodiment, the activated nonwoven webs of the present invention may be utilized advantageously in forming electric double layer capacitors (EDLCs). An EDLC is a device utilizing induced ions between an electronic conductor and an ionic conductor to store an electric charge. Specifically, electric charge accumulates on the electrode surface, and ions of opposite charge are arranged in the electrolyte side of the capacitor. Increased surface area of the capacitor allows for a larger charge accumulation. Increased porosity of the capacitor may improve electrolyte wetting and provides for rapid ionic motion.

Fibers produced according to the processes of the present invention display not only extremely small diameters, i.e., less than about 5 μm, but also excellent uniformity in fiber diameter. Thus, the webs produced from the fibers have high porosities as well as large specific surface areas. For the purposes of this disclosure, specific surface area is defined as surface area per unit mass. These characteristics enable activated carbon webs produced according to the processes of the present invention to function extremely well as EDLC's. Currently, EDLC's are often used as back-up power sources for electronic equipment and auxiliary power sources for mechanical operations in small electronic appliances. However, due to the good mechanical and electrical properties of the webs, the presently disclosed activated webs also show great promise in high energy density applications, such as may be utilized in forming high energy fuel cells for use in electric or hybrid vehicles or other high energy use applications.

In general, the process of the present invention includes electrostatic spinning of an aromatic polyamic acid composition. In one embodiment, the polyamic acid composition may be prepared according to known chemical processes wherein a dianhydride, such as a pyromellitic dianhydride (PMDA) or a biphenyltetracarboxylic dianhydride (BPDA) is reacted with an organic diamine in a solvent to form a solution of polyamic acid.

The organic diamines useful in the process are generally characterized by the formula: H₂N—R′—NH₂, wherein R′ may be selected from the following groups: aromatic, aliphatic, cycloaliphatic, combination of aromatic and alipahic, heterocyclic, bridged organic radicals wherein the bridge is oxygen, nitrogen, sulfur, silicon, or phosphorous, and substituted groups thereof.

In one embodiment, equimolar amounts of pyromellitic dianhydride (PMDA) and 4,4′-oxydianiline (ODA), both available from the Aldrich Chemical Company, may be copolymerized to form polyamic acid (PM) according to the following reaction:

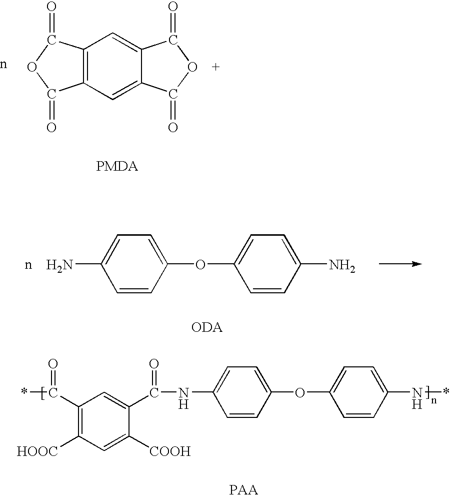

According to the present invention, once prepared, a polyamic acid solution may be electrostatically spun to produce polyamic acid fibers having extremely small diameters which may then be formed into a nonwoven web.

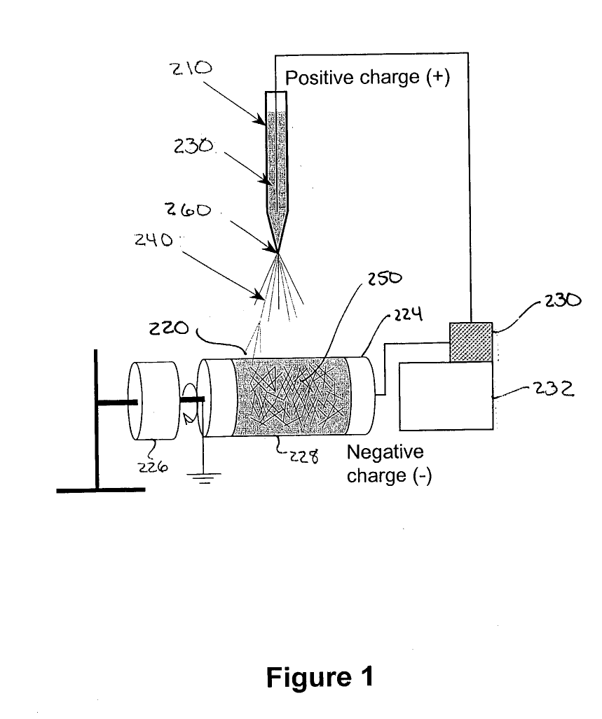

One embodiment of a system which may be used for electrostatically spinning a PM solution is illustrated in FIG. 1. In general, the system includes a capillary tube 210 containing a solution 230 of the polymer to be spun, and a collection point 220 within or adjacent to an electric field which may be induced by use of any suitable high voltage supplier 230. In one embodiment, the system may also include a voltage controller 232. In the embodiment shown in FIG. 1, the collection point 220 may be located on a collection device such as a take-up reel 224 which may be driven rotationally (as in the direction of the arrow designated 225) by a motor 226. In alternative embodiments, the collection device may alternatively be any suitable collecting or capturing device. Other possible collecting devices include, for example, a wire or polymeric mesh, such as may be utilized as an endless traveling forming fabric, or a water bath. Typically, the collection point 220 may be conductive, but this is not a requirement of the present process. In the embodiment illustrated in FIG. 1, the take-up reel 224 may be conductive, so as to aid in establishment of the electric field. For instance, the take up reel 224 may include an aluminum sheath 228.

In general, an electrostatic spinning process consists of the application of an electrical field to the polymer solution 230, inducing a charge on the individual polymer molecules. The polymer solution 230 can be held in the capillary tube 210 by its surface tension at the air-surface interface 260. Upon application of an electric field, a charge and/or dipolar orientation will be induced at the air-surface interface 260 which causes a force that opposes the surface tension. At a critical field strength, the repulsive electrostatic forces will overcome forces due to the surface tension, and a jet 240 of polymer material will be ejected from the capillary tube 210. The jet 240 is elongated and accelerated by the external electric field as it leaves the capillary tube 210. The trajectory of the jet 240 can be controlled by applying an appropriately oscillated electrostatic field, allowing for directional control of the jet 240. As the jet 240 travels in air, some of the solvent can evaporate, leaving behind charged polymer fibers which can be collected on the take-up reel 224. As the fibers are collected, the individual fibers may fuse, forming a nonwoven web 250 on the take-up reel 224.

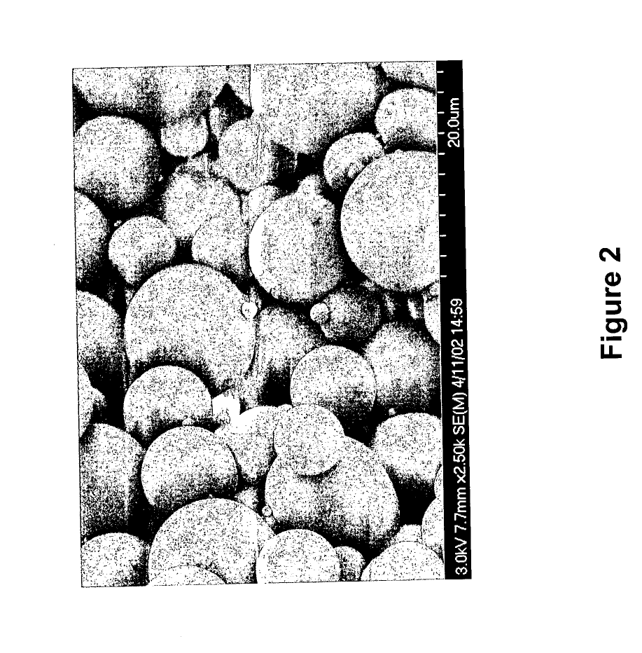

The critical field strength required to overcome the forces due to surface tension of the solution and form the jet will depend on many variables of the system. These variables include not only the type of polymer and solvent, but also the solution concentration and viscosity, as well as the temperature of the system. In general, characterization of the jet formed, and hence characterization of the fibers formed, depends primarily upon solution viscosity, net charge density carried by the electrospinning jet and surface tension of the solution. The ability to form the small diameter fibers depends upon the combination of all of the various parameters involved. For example, electrospinning of lower viscosity solutions will tend to form beaded fibers, rather than smooth fibers. In fact, many low viscosity, low molecular weight solutions will break up into droplets or beads, such as those shown in FIG. 2, rather than form fibers when attempts are made to electrostatically spin the solution. Solutions having higher values of surface tension also tend to form beaded fibers or merely beads of polymer material, rather than smooth fibers.

In the present process, it has been discovered that aromatic polyamic acid solutions may be electrostatically spun to form fibers with very small diameters. Specifically, solution viscosity and selection of solvent, when combined with other process parameters, such as temperature, for example, can play a critical role in the ability to form the small diameter polyamic acid fibers. For instance, in initial experiments, a polyamic acid solution including an N-methyl-2-pyrrolidone/hydrocarbon solvent was electrostatically spun at room temperature (approximately 25° C.) and a potential difference of about 15 KV. This extrudate could not be solidified in fiber form, even when a non-solvent (ethanol) was used in the polyamic acid solution. The results of this attempt to form polyamic acid fibers can be seen in FIG. 2, in which beads with diameters of approximately 10 μm were formed, rather than fibers. While it would be possible to electrostatically spin this solution at different process conditions, such as higher temperature or higher potential difference, practical considerations (i.e., costs, simplicity, etc.), may make such conditions undesirable. Accordingly, in a presently preferred embodiment, an electrostatic spinning process for polyamic acid is disclosed which may be carried out at or near ambient temperatures and reasonable levels of induced potential difference, such as less than about 30 KV.

It has been discovered that in order to electrostatically spin an aromatic polyamic acid solution, the concentration of the solution plays a key role. For example, a polyamic acid solution may be electrostatically spun if it includes between about 10 wt % and about 15 wt % aromatic polyamic acid. In one embodiment, the solution can include about 12 wt % polyamic acid.

In one embodiment, the solvent used to form the solution can have a boiling temperature of less than about 100° C. For example, the solvent may have a boiling temperature at atmospheric pressure of between about 60° C. and about 100° C. One example of a possible solvent includes a mixture of tetrahydrofuran and methanol. In general, a THF/MeOH solvent can include tetrahydrofuran and methanol in a ratio of between about 5:5 to about 8:2 by weight. In one embodiment, the solvent can include THF:MeOH in about a 4:1 ratio by weight.

Polyamic acid fibers having an extremely small diameter, for example less than about 5 μm can be formed according to the process. For instance, the present process may produce polyamic acid fibers having a diameter of less than about 3 μm, such as from about 200 nm to about 3 μm.

When forming the webs of the present invention from the spun fibers, the packing density of the web can be varied through modification of the take-up speed of the fibers at the take-up reel. For example, in one embodiment, take-up speed can be between about 100 m/min and about 500 m/min. In one embodiment, take-up speed can be about 400 m/min. For example, packing density of the web can increase as take-up speed increases. This might be expected since filament tension also increases with take-up speed yielding a tighter, more compact web. In addition, at higher take-up speeds, solidification of the fibers can be less complete when the fibers are wound on the take-up reel. Less solidification of the fibers as the fibers are wound can encourage increased adhesion between fibers in the web and promote formation of a stronger web.

The polyamic acid fibers and nonwoven webs produced according to the processes of the present invention may be subjected to further processing, as desired. For example, in one embodiment, polyamic acid fibers forming a nonowoven web may be chemically or thermally converted to the corresponding polyimide to produce a polyimide nonwoven web according to the following reaction:

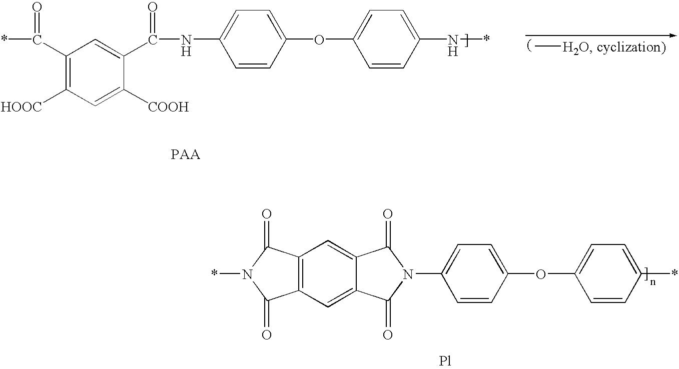

Polyamic acid conversion to the corresponding polyimide may be carried out according to any suitable chemical or thermal conversion process as is generally known in the art. For example, in one embodiment, chemical conversion of the web may be carried out at ambient temperatures by treatment with mixtures of aliphatic carboxylic acid anhydrides and tertiary amines. For example, acetic anhydride and pyridine or triethyl amine may be used. In an alternative embodiment, thermal conversion of the polyamic acid to the corresponding polyimide may be carried out. For example, in one embodiment a stepwise heat treatment process may be carried out which may covert the polyamic acid to the corresponding polyimide while concurrently removing any remaining solvent from the web. For example, stepwise heating of the web under air flow over a period of time (usually between about 4 and about 24 hours) to a temperature of between about 250° C. and about 350° C. can be used to thermally convert the fibers of the nonwoven web to the corresponding polyimide and remove any remaining solvent.

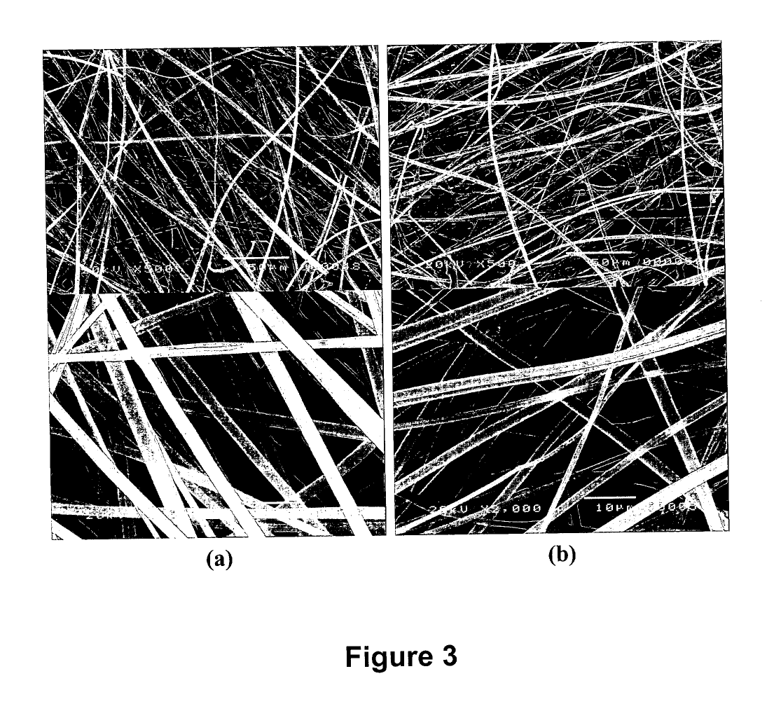

In one embodiment, as the nonwoven web is thermally converted from polyamic acid to the corresponding polyimide, the diameters of the fibers can decrease somewhat, providing a nonwoven web formed of even smaller diameter fibers. For instance, FIG. 3 includes scanning electron microscope images of a nonwoven web formed of polyamic acid fibers at FIG. 3(a) compared to the same web after a stepwise thermal imidization process at FIG. 3(b). Both webs are shown at ×500 magnification (top) and at ×2000 magnification (bottom). As can be seen, the fibers lose a portion of their diameter upon imidization. It is believed that the fibers may lose from about 25% to about 60% of the original diameter upon completion of the stepwise thermal conversion process.

In certain embodiments of the present invention, the electrostatically spun polyimide webs may be further processed. For example, in one embodiment, the polyimide webs may be further processed so as to enhance their electrochemical properties, such as through a carbonization and/or graphitization process.

In general, in order to carbonize the web, the polyimide web may be heated at a rate of between about 5° C./min and about 20° C./min to a temperature of at least about 700° C., and held at that temperature for a period of time, such as, for instance, about one hour, so as to carbonize at least a portion of the unsaturated bonds in the polymers. For example, the webs may be held at a temperature of between about 700° C. and about 1000° C. for a period of about one hour to carbonize a portion of the unsaturated bonds of the polymer molecules. Additionally, if desired, the webs may be further heat treated to a higher temperature yet, such as for example up to about 2200° C., so as to graphitize the polyimide web.

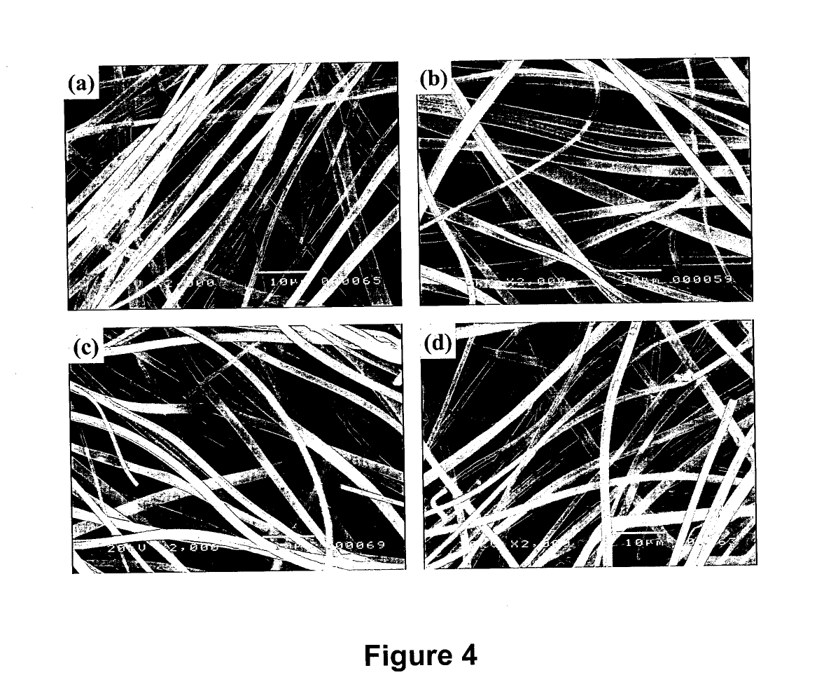

In this embodiment, carbonization and graphitization processes may further reduce the diameter of the fibers forming the nonwoven web. FIGS. 4(a) through 4(d) are photographs of a nonwoven polyamic acid web (FIG. 4(a)), the same web following a stepwise thermal imidization conversion (FIG. 4(b)), the web following a carbonization process at 700° C. for an hour (FIG. 4(c)), and the web following a subsequent carbonization process at 1000° C. for an hour (FIG. 4(d)). As can be seen the fibers continue to decrease in diameter through each process, with a decrease in fiber diameter of about 50% throughout the entire process. For example, an electrostatically spun web formed of polyamic acid fibers of between about 2 μm and about 3 μm in diameter can be formed according to the process of the present invention. Following imidization, carbonization, and graphitization processes, the same web fibers can have a diameter of between about 1 μm and about 2 μm.

In general, the electrical conductivity of the carbonized polyimide web can increase in proportion to the final heat treatment temperature of the carbonization and/or graphitization process. For example, an uncompressed polyimide web carbonized at about 1000° C. for about one hour can display an electrical conductivity of about 2.5 S/cm, and a similar uncompressed web graphitized at about 2200° C. for about an hour can display an electrical conductivity of about 5.3 S/cm. (For purposes of this disclosure, S indicates siemens, or the inverse of the resistance measured in ohms.) As the electrical conductivity of these materials may be further increased under the application of pressure, i.e., when the web is compressed, it is possible through the processes of the present invention to form a highly porous material with very high specific surface area and extremely high electrical conductance.

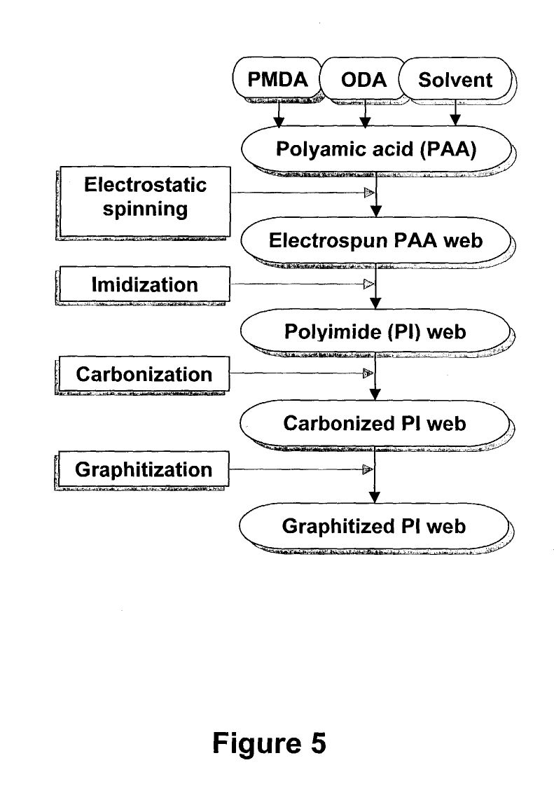

FIG. 5 is a flow diagram illustrating embodiments of the present invention. According to these embodiments, a solution of polyamic acid may be formed from the desired solvent and monomers. This solution may then be electrostatically spun to form a polyamic acid nonwoven web of very small diameter fibers. In some embodiments, the polyamic acid may then be converted to the corresponding polyimide, such as through a thermal conversion process. In some embodiments, the web may be further treated by a carbonization process. In still other embodiments, the web may be further treated by a graphitization process. In these embodiments, nonwoven materials of extremely small diameter fibers and displaying excellent electrical and mechanical properties may be formed. Such materials are very well suited for a wide variety of electrochemical applications, and are particularly well suited for inclusion in electrical double layer capacitors and high-energy fuel cells.

EDLCs are formed from a pair of polarizable electrodes and an electrolyte solution. The capacitance is accumulated in the electric double layer formed at the interface between the polarizable electrodes and the electrolyte solution. In one embodiment, activated polyimide nonwoven webs of the present invention can be utilized as electrodes in an EDLC. In this embodiment, the web can be carbonized and/or graphitized at a specific heat treatment temperature to obtain a desired conductivity. The activated webs of the present invention may then be utilized in forming an EDLC with a specifically designed electrical storage capacity. Moreover, due to the high specific surface area and beneficial pore structure of the activated webs of the present invention, EDLCs with extremely high energy density capabilities, such as may be utilized in larger fuel cell applications, are possible embodiments of the present invention.

The electrolyte solution of an EDLC according to the present invention may be a non-aqueous organic electrolyte system or an aqueous electrolyte system, as is generally known in the art.

One example of an organic electrolyte system which can be utilized in the EDLCs of the present invention includes from about 0.5 mol/L to about 3 mol/L of a salt comprising cations such as, for example, tetraalkylammonium (e.g., tetraethylammonium and tetramethylammonium), lithium ions and/or potassium ions, and anions such as tetrafluoroborate, perchlorate, hexafluorophosphate, bis-trifluoromethanesulfonyl imide or tris-fluoromethanesulfonyl methide. The salt may be dissolved in a nonprotonic solvent such as, for example, propylene carbonate or ethylene carbonate and/or a low viscosity solvent such as, for example, diethyl carbonate, dimethyl carbonate, ethylmethyl carbonate, dimethyl ether or diethyl ether.

In an alternative embodiment, an aqueous electrolyte system may be utilized. For example, in one embodiment, an aqueous solution comprising from about 5 wt % to about 100 wt % H₂SO₄ may be utilized. In an alternative embodiment, an aqueous electrolyte system of a hydroxide solution may be used. For example, an aqueous electrolyte solution of potassium hydroxide, sodium hydroxide, or lithium hydroxide, or a mixture thereof may be used. In one embodiment, an aqueous solution of from about 0.5 M to about 20 M of KOH may be used.

As capacitance of an EDLC may vary depending on the electrolyte system, further specification of the characteristics of the EDLC may be realized through selection of a specific electrolyte system. The above-mentioned exemplary electrolyte systems are non-limiting examples of systems which may be used in the disclosed devices, and any suitable electrolyte system known in the art may optionally be utilized in the EDLCs of the present invention.

Reference now will be made to various embodiments of the invention, one or more examples of which are set forth below. Each example is provided by way of explanation of the invention, not as a limitation of the invention. In fact, it will be apparent to those skilled in the art that various modifications and variations may be made of this invention without departing from the scope or spirit of the invention.

### EXAMPLE 1

Polyamic acid (PM) precursors for electrostatic spinning were prepared by copolymerizing pyromellitic dianydride (PMDA, Aldrich Chemical Company) and 4,4′-oxydianiline (ODA, Aldrich Chemical Company) in a THF/MeOH mixed solvent having a boiling temperature of 66° C. to form a solution consisting of 12 wt % PM, 70.4 wt % THF, and 17.6 wt % MeOH. The procedure consisted of initially adding the desired amount of PMDA to the mixed solvent to ensure complete dissolution and then adding equimolar amount of ODA. The solution was then stirred at room temperature for 1 hour, forming a viscous solution of PM in the THF/MeOH mixed solvent.

A Brookfield viscometer (LVDV-II, USA) was used to measure the apparent viscosity of the PM solution at 25° C. The inherent and intrinsic viscosities were determined through flow time measurements of diluted solutions with a sequence of concentrations using an Ubbelohde viscometer at 25° C.

The intrinsic viscosity of the PM solution was found to be 1.413 dl/g at 25° C. The 12 wt % solution exhibited non-Newtonian flow behavior.

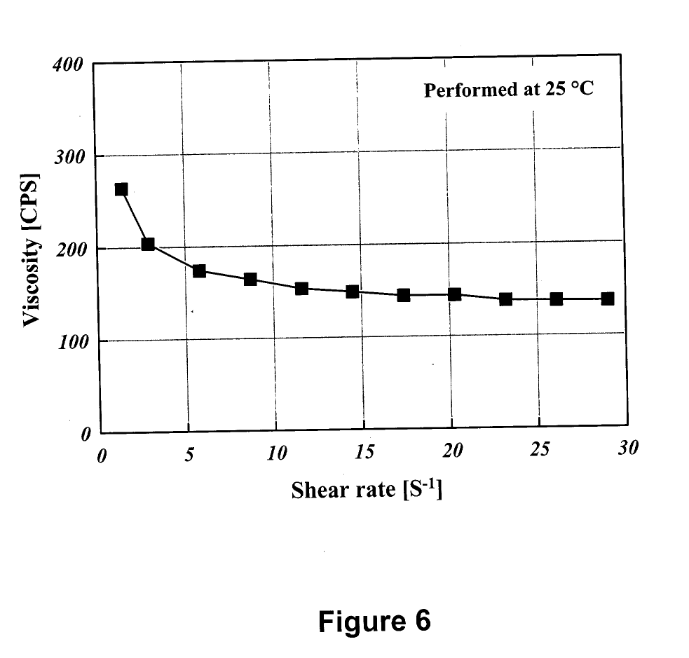

FIG. 6 shows the viscosity of the 12 wt % solution as a function of shear rate. As FIG. 6 shows, at low rates of shear the viscosity of the 12 wt % solution decreased with shear rate. The viscosity then becomes relatively constant at higher shear rates. This behavior is typical for polymer solutions produced by condensation reactions.

### EXAMPLE 2

The PM solution of Example 1 was electrostatically spun to form a nonwoven web using an electrostatic spinning apparatus similar to that illustrated in FIG. 1. The apparatus consisted of a 15 kV DC power supply 230 (HYP-303D, Han Young Co., Korea) equipped with a positively-charged capillary 210 from which the polymer solution 230 was extruded. The apparatus also included a negatively-charged take-up reel 224 for collecting the fibers. The procedure consisted of filling a syringe with the PM solution, and then extruding the solution at room temperature through the syringe needle (the capillary) at a flow rate of 20 g/hr. The inner diameter of the syringe needle was 0.41 mm, and the distance between the exit of the syringe needle and the outer surface of the take-up reel was 6-7 cm.

Remaining solvent removal and imidization of the PM fibers were then performed concurrently by stepwise heat treatments under air flow at 40° C. for 12 hours, 100° C. for 1 hr, 250° C. for 2 hr, and 350° C. for 1 hr. The heating rate between steps was 5° C./min, and the flow rate of air was 1 L/min. Shrinkage during the heat treatment was minimized by clamping the web 250 on the aluminum sheath 228 as it was spun.

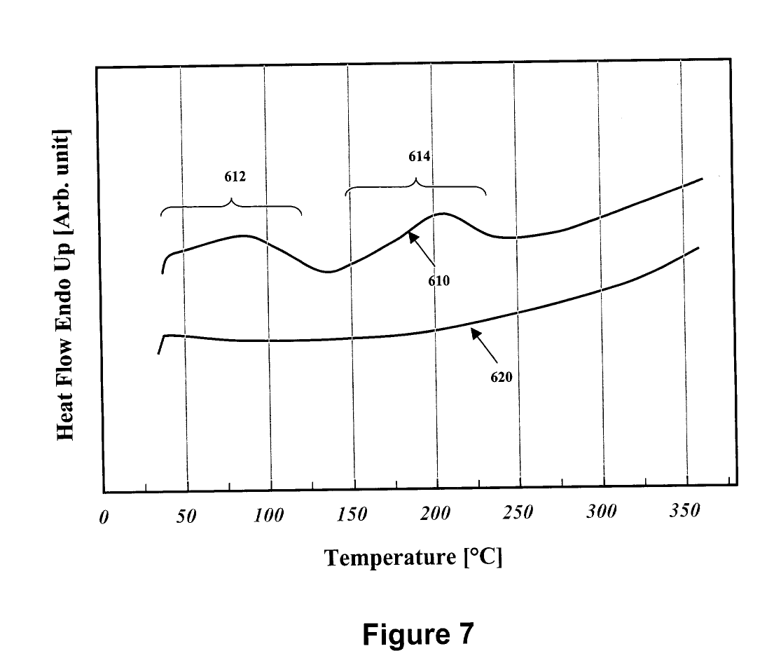

The stepwise thermal imidization process converted the light yellow colored PM web into a dark yellow colored PI web. The overall yield for this step was 81%. FIG. 7 illustrates differential scanning calorimeter thermograms of the electrospun PM web 610 and the same web following imidization 620. As can be seen, the thermogram of the PM web 610 shows two broad endothermic peaks, most likely representing solvent evaporation 612 and imidization 614.

When samples were subjected to a second DSC scan 620, no peak was detected, indicating that imidization was complete.

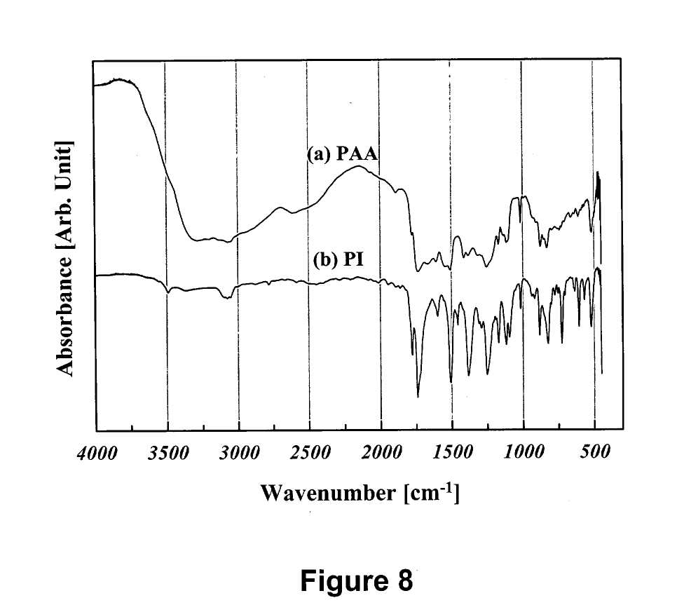

The IR spectrum illustrated in FIG. 8 of the initial PM web contains peaks associated with hydrogen bonded amine/hydroxyl groups (FIG. 8(a)), indicated by broad absorption band between 2500 and 3500 cm⁻¹. After the web is converted to PI, this broad band disappears (FIG. 8(b)).

### EXAMPLE 3

Samples of the thermally-cured PI web formed in Example 2 were sandwiched between polished artificial graphite plates and then heated to one of the following: 700° C., 800° C., 900° C., or 1000° C. in a tubular furnace under nitrogen atmosphere. All samples were heated at a heating rate of 1° C./min and held at the final temperature for one hour.

Portions of the PI web that had been carbonized at 1000° C. were subsequently graphitized under He atmosphere at 1800° C. and 2200° C. at heating rates of 2⁰° C./min and 10° C./min, respectively. Both of these samples were held at the final temperature for 15 min.

The electrical resistances in the winding direction of the webs were measured by the four-point probe method (Model 3387-11, Kotronix, Japan). The cross sectional area of the web, A, was calculated by multiplying the measured width by the measured thickness of the sample web. The electrical conductivity, σ, was calculated on the basis of the following equation:

σ=L/(AR)

wherein

R is electrical resistance in Ω,

A is cross sectional area in cm², and

L is distance between the electrodes in cm.

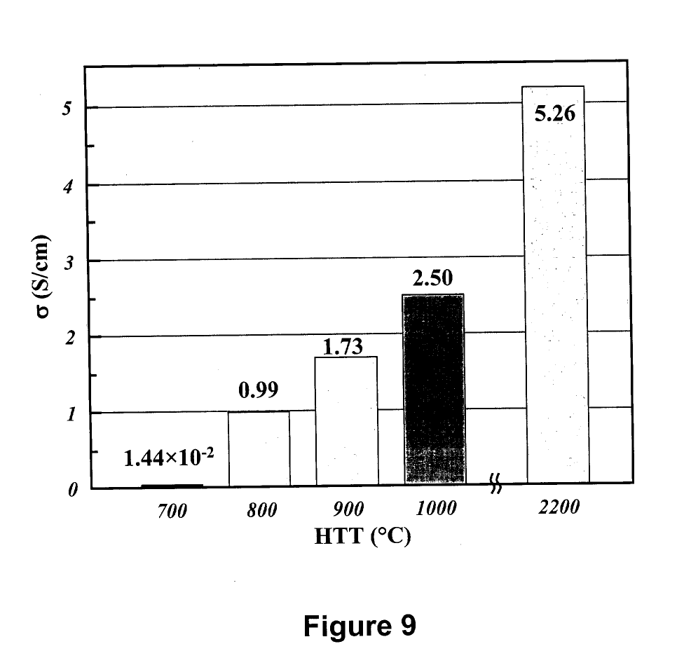

The electrical conductivities of the treated webs are illustrated in FIG. 9. As can be seen, the electrical conductivities of the carbonized PI webs increased with increase in the carbonization temperature. This is believed to be the direct result of the enhanced crystallinity. The conductivity of the PI web after being carbonized at 1000° C. was 2.5 S/cm. The measured conductivity increased to 5.26 S/cm as the heat treatment temperature increased to 2200° C.

After the carbonization and graphitization, the flexibility of the web was adequate for compression molding. The morphology of the fibers was found to be rather amorphous.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A process for forming a nonwoven web comprising:
providing a solution comprising a solvent and comprising between about 10 wt % and about 15 wt % aromatic polyamic acid;
electrostatically spinning the aromatic polyamic acid solution in an electric field so as to form a plurality of fibers comprising aromatic polyamic acid;
collecting the fibers on a collection device; and
adhering the fibers one to another to form a nonwoven web.

2. The process of claim 1, wherein the electric field comprises a potential difference of less than about 30 KV.

3. The process of claim 1, wherein the solution is electrostatically spun at ambient temperature.

4. The process of claim 1, wherein the solvent has a boiling point at atmospheric pressure of less than about 100° C.

5. The process of claim 4, wherein the solvent comprises a mixture of tetrahydrofuran and methanol.

6. The process of claim 1, further comprising forming the solution comprising between about 10 wt % and about 15 wt % aromatic polyamic acid by reacting equimolar amounts of a dianhydride and an organic diamine in the solvent.

7. The process of claim 6, wherein the dianhydride is a pyromellitic dianydride or a biphenylcarboxylic dianhydride.

8. The process of claim 1, further comprising converting the aromatic polyamic acid to polyimide following the electrostatic spinning of the polyamic acid solution.

9. The process of claim 8, wherein the aromatic polyamic acid is thermally converted to polyimide.

10. The process of claim 9, wherein the thermal conversion comprises a stepwise thermal conversion to a final temperature of about 350° C.

11. The process of claim 8, further comprising carbonizing at least a portion of the unsaturated bonds of the polyimide.

12. The process of claim 11, further comprising graphitizing the nonwoven web.

13. A fiber comprising an aromatic polyamic acid, wherein the fiber has an average cross sectional diameter of less than about 5 μm.

14. The fiber of claim 13, wherein the fiber has been electrostatically spun from a solution comprising the aromatic polyamic acid and a solvent.

15. The fiber of claim 13, wherein the fiber has an average cross-sectional diameter of less than about 3 μm.

16. The fiber of claim 13, wherein the fiber has an average cross-sectional diameter of between about 200 nm and about 3 μm.

17. The fiber of claim 13, wherein the aromatic polyamic acid has a chemical structure of

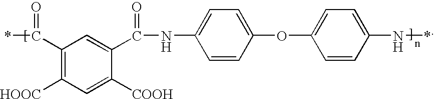

18. A fiber comprising a polyimide, wherein the fiber has an average cross sectional diameter of less than about 5 μm.

19. The fiber of claim 18, wherein the polyimide has been converted from a polyamic acid precursor.

20. The fiber of claim 19, wherein the polyimide has been thermally converted from a polyamic acid precursor.

21. The fiber of claim 19, wherein the polyimide has been chemically converted from a polyamic acid precursor.

22. The fiber of claim 18, wherein the fiber has an average cross-sectional diameter of less than about 3 μm.

23. The fiber of claim 18, wherein the fiber has an average cross-sectional diameter of between about 200 nm and about 3 μm.

24. The fiber of claim 18, wherein the polyimide has a chemical structure of

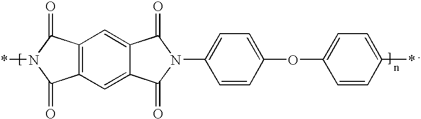

25. A nonwoven web comprising a plurality of electrostatically spun fibers each having an average cross-sectional diameter of less than about 5 μm, wherein the plurality of fibers have been electrostatically spun from a solution comprising an aromatic polyamic acid and a solvent.

26. The nonwoven web of claim 25, wherein the electrostatically spun fibers comprise polyamic acid.

27. The nonwoven web of claim 25, wherein the electrostatically spun fibers comprise polyimide.

28. The nonwoven web of claim 27, wherein the polyimide has been thermally converted from the aromatic polyamic acid.

29. The nonwoven web of claim 27, wherein at least a portion of the unsaturated polyimide bonds have been carbonized.

30. The nonwoven web of claim 29, where in the web has an electrical conductivity greater than about 0.0144 S/cm when the web is not compressed.

31. The nonwoven web of claim 29, wherein the web has an electrical conductivity greater than about 1.0 S/cm when the web is not compressed.

32. The nonwoven web of claim 29, wherein the web has an electrical conductivity greater than about 1.73 S/cm when the web is not compressed.

33. The nonwoven web of claim 29, wherein the polyimide has been graphitized.

34. The nonwoven web of claim 33, wherein the web has an electrical conductivity greater than about 2.50 S/cm when the web is not compressed.

35. The nonwoven web of claim 33, wherein the web has an electrical conductivity of at least about 5.26 S/cm when the web is not compressed.

36. The nonwoven web of claim 33, wherein the web has an electrical conductivity between about 2.50 S/cm and about 5.5 S/cm when the web is not compressed.

37. An electrical double layer capacitor comprising:
A first electrode, wherein the electrode comprises a nonwoven web comprising activated polyimide fibers having an average diameter of less than about 5 μm; and
an electrolyte in electrical communication with the first electrode.

38. The electrical double layer capacitor of claim 37, further comprising a second electrode comprising a second nonwoven web comprising activated polymide fibers having an average diameter of less than about 5 μm.

39. The electrical double layer capacitor of claim 37, wherein the electrolyte comprises an organic electrolyte solution.

40. The electrical double layer capacitor of claim 37, wherein the electrolyte comprises an aqueous electrolyte solution.
